(19) United States
(12) Patent Application Publication
(10) Pub. No.: US 2007/0002884 A1
(43) Pub. Date: Jan. 4, 2007

(54) Usage of multiple SSIDs for doing fast WLAN network discovery

(75) Inventors: Mikko Jaakkola, Lempaala (FI); Arto Suomi, Tampere (FI); Jari Poyhonen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/372,037

(22) Filed: Mar. 10, 2006

(30) Foreign Application Priority Data
Jun. 30, 2005 (EP) 05 014 202.5

(51) Int. Cl. H04L 12/28

(52) U.S. Cl. 370/431; 455/515

(57) ABSTRACT

The invention proposes a method for scanning an access network, comprising the steps of sending a plurality of probe requests directed to access networks within a first time period, waiting for responses to the plurality of requests within a second time period following the first time period, and detecting the access networks based on the received responses. The invention also proposes a corresponding device for wireless communication.

### BACKGROUND OF THE INVENTION:

1. Field of the invention

The invention relates to a method and a device for wireless communication by which a scan for access networks can be performed.

2. Description of the related art

This invention is related to a network in which a device for wireless communication may establish a connection to one of several different access networks. Examples for such access networks are Wireless Local Area Networks (WLAN), wherein each network is identified by a Service Set IDentifier (SSID).

When connecting to WLAN networks, the user usually needs to perform a scan request in order to see what networks are surrounding the area. The scanning procedure may be a passive scan, in which the WLAN station (STA) listens to beacons delivered from surrounding Access Points (AP), or an active scan, in which the WLAN station sends probe requests and waits for an answer.

However, sometimes not all the networks can be revealed by ordinary 802.11 scan process (either active or passive). Thus, in order to truly discover all the surrounding networks, all of the network profiles stored in the system needs to be scanned separately. This takes a lot of time, as will be described in the following.

When doing an active scan through the WLAN network, the user can either use broadcast scan or directed scan. Broadcast scan normally reveals all the networks, but in many cases WLAN networks are built to utilize proprietary technologies like so-called hidden SSID networks or multiple SSID networks. These networks require the mobile system to probe the network with specific network name (SSID) in order to reveal their bases to all channels and usually this takes a lot of time. In detail, one scan takes around 0.5 second and performing scan for 5 SSIDS would thus take around 2.5 seconds and for 10 SSIDS it would take 5 seconds and so on.

While the scan operation is performed, sending and receiving of data MPDUs (MAC (Medium Access Control) Protocol Data Unit) is not possible due to implementation limitation or it is very slow, so that the long time needed for the scan results affect applications, in particular applications that have real time requirements like voice.

### SUMMARY OF THE INVENTION

Hence, it is an object of the present invention to solve the problem mentioned above and to minimize the time needed for discovering networks.

This object is solved by a method for scanning an access network, comprising the steps of

sending a plurality of probe requests directed to access networks within a first time period,

waiting for responses to the plurality of requests within a second time period following the first time period, and

detecting the access networks based on the received responses.

Alternatively, the above object is solved by a device for wireless communication, comprising a sending means, a receiving means and a detection means for detecting access networks, wherein the sending means is adapted to send a plurality of probe requests, which are directed to access networks, respectively, during a first time period, the receiving means is adapted to receive probe responses which are based on the sent probe requests during a second time period following the first time period, and the detection means is adapted to detect the access networks based on the received probe responses.

That is, according to the present invention, all probe requests are sent during a first time period, i.e., without waiting on probe responses. During a second time period which follows the first time period, it is waited for possible probe responses.

Hence, the time required for performing a scan operation with respect to a plurality of networks can be considerably reduced, since the scan operation is not performed for each network, but the scan operations (sending a probe request and waiting for a response) for the plurality of networks are performed simultaneously. Further advantageous developments are set out in the dependent claims.

For example, each probe request may comprise an identity of an access network in order to identify this access network. This identity may be a SSID (Service Set IDentifier), for example.

The probe requests may be sent as a burst. In this case, the time for sending the probe requests can be further minimized.

Furthermore, a scan request including a list of access network identities may be received before the probe requests are sent. That is, the scan request can be designed such that one scan request comprises a plurality of access network identities (e.g., SKIDS, as mentioned above).

The networks may be a Wireless Local Area Networks (WLAN), and the device for wireless communication may be a WLAN device.

The invention also proposes a host device for hosting a device for wireless communication, the host device comprising means for generating a scan request such that a list of access network identities are included in one scan request, and means for sending the generated scan request to the device for wireless communication.

Furthermore, the host device and the device for wireless communication may be combined in a system.

The method according to the invention may be realized as a computer program product for a processing device, comprising software code portions for performing the steps of the method according to the invention when the program is run on the processing device. The computer program product may comprise a computer-readable (readable for the processing device) medium on which the software code portions are stored.

In particular, the processing device may be part of a WLAN device, so that the computer program may be stored in a memory of the WLAN device.

### BRIEF DESCRIPTION OF THE DRAWINGS

The invention is described by referring to the enclosed drawings, in which:

FIG. 1 shows a basic structure of a WLAN system comprising a WLAN device and several Access Points of different WLAN networks,

FIG. 2 illustrates a WLAN host API architecture as applicable in the embodiment of the invention,

FIG. 3 shows a signalling flow of a scanning procedure according to an embodiment of the present invention, and

FIG. 4 shows a terminal according to the embodiment of the invention.

### DETAILED DESCRIPTION OF THE PREFERRED EMBODIMENT

In the following, a preferred embodiment of the present invention is described by referring to the attached drawings.

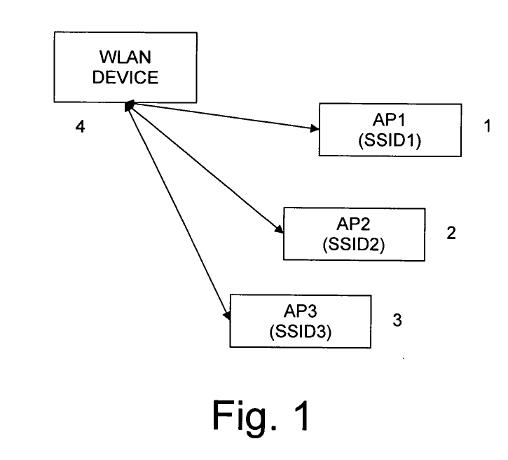

According to the preferred embodiment, the invention is applied to a system of Wireless Local Area Networks (WLANs) having a structure in the way as shown in FIG. 1, for example. In particular, a WLAN device 4 (as an example for a device for wireless communication) may scan for surrounding networks. A first network indicated by the Service Set IDentifier SSID1 is reachable via a first Access Point AP1 (as an example for an access entity), denoted by reference numeral 1. A second network indicated by the Service Set IDentifier SSID2 is reachable via a second Access Point AP2, denoted by reference numeral 2. A third network indicated by the Service Set IDentifier SSID3 is reachable via a third Access Point AP2, denoted by reference numeral 2. The double-headed arrows between the WLAN device 4 and the Access Points 1 to 3 indicate exchange of signalling, namely sending of probe requests and probe responses, as will be described in the following.

It is noted that the WLAN device can be a WLAN card to be inserted in a laptop computer, in a PDA (personal digital assistant), a mobile phone, a WLAN enabled device connected to the host by some other wireless technology e.g. bluetooth, a USB (Universal Serial Bus) stick inserted in a USB port of a laptop computer or a fixed personal computer or the like. In these cases, the laptop computer and the fixed personal computers are examples for host devices. Furthermore, the WLAN device can itself be a laptop computer having an on-board WLAN functionality, a WLAN enabled phone or the like. In these cases, the WLAN device and the host device are arranged within one entity, and may only be logically separated.

As described above, according to the present embodiment, instead of sending each probe request separately and waiting for response to it before sending the next one, all probe requests are sent as a burst and then it is waited responses to them. This can be done by introducing an API (Application Programming Interface) for WLAN MAC (Media Access Control) hardware that allows specifying multiple SKIDS in one scan request and modifying firmware code so that all the probe requests are send one after another with different SKIDS specified in the list. This minimizes the overall waits during scans and thus making scanning much more effective.

Namely, the conventional directed scanning is performed so that first terminal sends a probe request with specific network name, and then it waits for all possible responses. Typically sending the probe request takes around 700 microseconds and then waits for the probe responses. The period for waiting varies usually between 30-70 milliseconds (specified by the host). In practice, the system keeps on waiting 97-99% of the whole scan time.

According to the present embodiment, semantics are added to a scan request which allow a host to specify more than one SSID into one logical scan request. This scan request is then split at firmware level into multiple probe requests that are sent one after another thus speeding scans significantly. This would allow the host to send e.g. 10 probe requests that would take around 7 ms and after that system would wait the mentioned 30-70 milliseconds for the responses thus improving the utilization of the scans by tenfold.

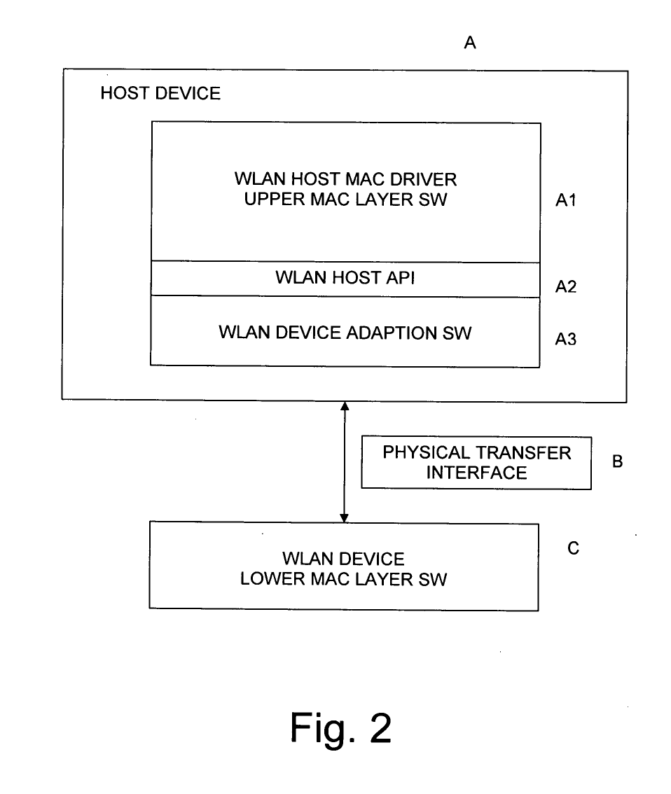

The host API and the WLAN device firmware are described in the following in connection with FIG. 2, which shows the logical structure of a host device A and a WLAN device C.

The host device A, which hosts the WLAN device C, comprises the WLAN host MAC driver Al, which is an upper MAC layer software (SW). The above-mentioned WLAN host API A2 provides a connection to WLAN device adaptation software (SW) A3. This WLAN device adaptation software converts the logical WLAN operations defined by the WLAN host API to WLAN device specific commands and vice versa.

The host device A and the WLAN device C are connected via a physical transfer interface B (e.g., USB in case the WLAN device is included in a USB stick to be inserted in a USB port of a computer). In the WLAN device, the lower MAC layer software (SW) is carried out, and it is realized by the WLAN device firmware code, as mentioned above.

That is, actually the WLAN MAC is divided in two parts in practise: part of the MAC is implemented as hardware based having firmware (i.e., the lower MAC layer software of the WLAN device) and part of the MAC is software based (i.e., the upper MAC layer software).

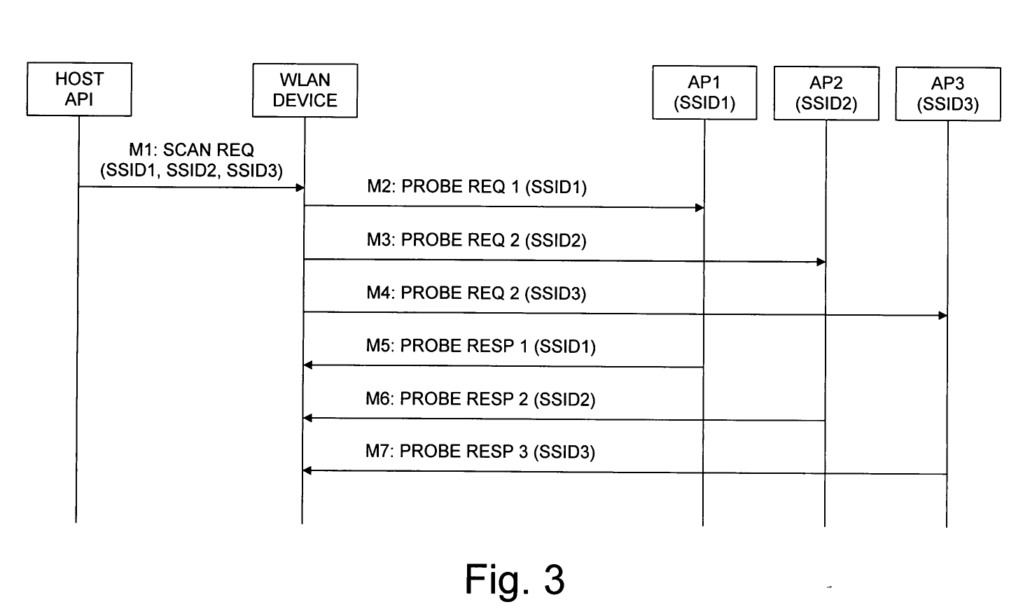

FIG. 3 shows a signalling flow of the scan procedure according to the present embodiment.

Here, a case is assumed that there are three surrounding networks, as illustrated in FIG. 1. In message M1, a single scan request M1 is forwarded from the WLAN API to the WLAN device. This single scan request contains the SSIDS to which probe requests are to be sent: SSID1, SSID2 and SSID3. That is, the scan request is designed in such a way that multiple SSIDS can be defined.

The WLAN device generates a plurality of probe requests M2 to M4. Probe Req 1 (M2) is directed to SSID1, Probe Req 2 (M3) is directed to SSID2 and Probe Req 3 is directed to SSID3. All these probe requests are sent sequentially, i.e., closely one after the other. Preferably, the probe requests are sent as a burst, i.e., with minimum time between the probe requests.

Since it usually takes some time to generate the probe responses in the Access Points, the probe responses will arrive considerably later than the last probe request (here M4) was sent. In the present case, it is assumed that all Access Points react by sending probe responses. That is, in M5, Probe Resp 1 from SSID1 is sent, in M6, Probe Resp 2 from SSID2 is sent, and in M7, Probe Resp 2 from SSID3 is sent.

Hence, the probe requests M2 to M4 are sent during a first time period, and the probe responses M5 to M7 are received thereafter, i.e., during a second time period following the first time period.

It is noted that the order of sending the probe responses does not necessarily correspond to the order of sending the probe requests. Different delays may be caused between the different APs in sending the probe responses due to differences in the operation speed, distance or the like.

Thus, the scan operation according to the present embodiment is n (n stands for the number of SKIDS in scan) times faster than the normal scan. However, the practical limit on n is around 5-20 SSIDS. This invention improves significantly power-consumption during scans. Also WLAN UIs can be more responsive in showing all the surrounding networks.

Furthermore, unnecessary waiting is avoided, for example in a case, in which no response from the designated SSID is received. In the prior art, order to determine that there is no response, some predefined time (Max₁₃Response₁₃Time) has to be awaited first, before a new probe request can be sent. According to the present embodiment, the whole scan only takes this predefined time.

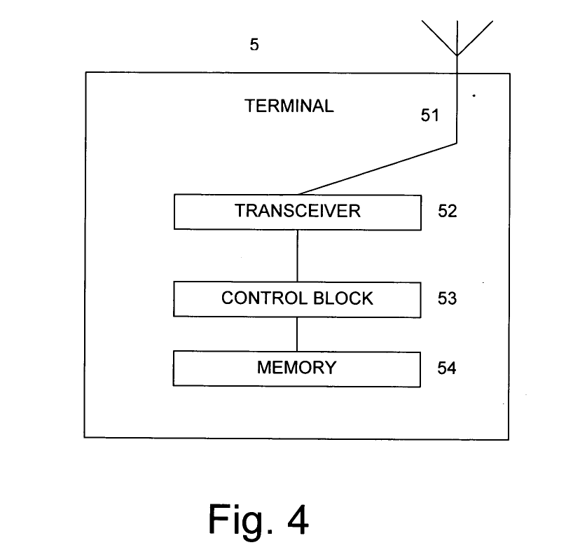

FIG. 4 shows a block diagram for a WLAN device according to the present embodiment. The terminal 5 comprises an antenna 51, a transceiver 52, a control block 53 and a memory 54. In detail, the control block 53 executes the code stored in the memory 54. Thus, as described above, the control block 53 serves as a detection means and instructs the transceiver 52 to send the probe frames as a burst and to receive probe responses, and performs the detection of WLANs.

The invention is not limited to the embodiment described above, and various modifications are possible.

For example, the invention is not limited to WLAN, but can also be applied to other radio networks in which it is necessary to perform a scan operation in order to detect access networks.

Furthermore, the invention also applies to chips capable of receiving commands through host API, to cause WLAN MAC chip to operate as described above. A WLAN device according to the present invention can be a device containing WLAN MAC and WLAN PHY layers and memory for storing software and a processor to execute the software.

The invention can also be realized by computer program product. The computer program product, i.e., the computer code may be stored on a medium, e.g., a memory card, a RAM (Random access memory) or a ROM (read only memory) or a harddrive.

1. A method for scanning an access network, comprising the steps of:
sending a plurality of probe requests directed to access networks within a first time period;
waiting for responses to the plurality of requests within a second time period following the first time period; and
detecting the access networks based on the received responses.

2. The method according to claim 1, wherein each probe requests comprises an identity of an access network.

3. The method according to claim 1, wherein the probe requests are sent as a burst.

4. The method according to claim 2, further comprising the step of:
receiving a scan request including a list of access network identities,
wherein the receiving step is performed before the sending step.

5. The method according to claim 1, wherein the access networks are Wireless Local Area Networks.

6. A device for wireless communication, comprising:
a sending means configured to send a plurality of probe requests, which are directed to access networks, respectively, during a first time period;
a receiving means configured to receive probe responses which are based on the sent probe requests during a second time period following the first time period; and
a detection means for detecting access networks, wherein
the detection means is configured to detect the access networks based on received probe responses.

7. The device according to claim 6, wherein each probe requests comprises an identity of an access network.

8. The device according to claim 6, wherein the sending means is configured to send the probe requests as a burst.

9. The device according to claim 7, wherein the detection means is configured to receive a scan request including a list of access network identities before the probe requests are sent by the sending means.

10. The device according to claim 6, wherein the networks are Wireless Local Area Networks (WLAN) and the device for wireless communication is a WLAN device.

11. A host device for hosting a device for wireless communication, the host device comprising:
means for generating a scan request such that a list of access network identities are included in one scan request; and
means for sending the generated scan request to the device for wireless communication.

12. The host device according to claim 11, wherein the networks are Wireless Local Area Networks (WLAN) and the device for wireless communication is a WLAN device.

13. A system comprising:
a host device for hosting a device for wireless communication, the host device comprising means for generating a scan request such that a list of access network identities are included in one scan request and means for sending the generated scan request to the device for wireless communication and;
a device for wireless communication comprising a sending means configured to send a plurality of probe requests, which are directed to access networks, respectively, during a first time period, a receiving means configured to receive probe responses which are based on the sent probe requests during a second time period following the first time period and a detection means for detecting access networks, wherein the detection means is configured to detect the access networks based on received probe responses.

14. A computer program product embodied on a computer readable medium, comprising software code portions for performing, when the computer program product is executed on a processing device, the steps of:
sending a plurality of probe requests directed to access networks within a first time period;
waiting for responses to the plurality of requests within a second time period following the first time period; and
detecting the access networks based on received responses.

15. The computer program product according to claim 14, wherein the software code portions are stored on the computer-readable medium.

16. The computer program product according to claim 14, wherein the processing device is part of a WLAN device.
